(19) United States
(12) Patent Application Publication
(10) Pub. No.: US 2015/0339373 A1
(43) Pub. Date: Nov. 26, 2015

(54) GRAPHICAL INTERFACE FOR RELEVANCE-BASED RENDERING OF ELECTRONIC MESSAGES FROM MULTIPLE ACCOUNTS

(71) Applicants: Matthew Christian Carlson, Seattle, WA (US); Alexander Frank, Bellevue, WA (US)

(72) Inventors: Matthew Christian Carlson, Seattle, WA (US); Alexander Frank, Bellevue, WA (US)

(21) Appl. No.: 14/282,760

(22) Filed: May 20, 2014

(51) Int. Cl. G06F 17/30; H04L 12/58

(52) U.S. Cl. CPC G06F 17/30601; G06F 17/3053; H04L 51/04

(57) ABSTRACT

A method and a device are disclosed including a user interface software component configured to dynamically display and manage grouped graphical representations, such as tiles, of electronic data and messages, such as files and emails, that are rendered based on relevance scores, and are associated with two or more user accounts. The messages may be grouped visually or logically. The user interface may automatically categorize messages by assigning certain attributes based heuristics or other information. The user interface is further configured to allow zooming in and out for more or less details, respectively. The user interface is further configured to allow automatic and/or dynamic changes to the appearance and contents of tiles based on the relevance scores and other factors, and further allow searching for, dispositioning, and taking various actions on one or a group of messages.

### CROSS-REFERENCE(S) TO RELATED APPLICATION(S)

The present application claims the benefit of the filing date of the U.S. Provisional Patent Application 61/826,015, entitled “GRAPHICAL INTERFACE FOR RELEVANCE-BASED RENDERING OF ELECTRONIC MESSAGES FROM MULTIPLE ACCOUNTS,” filed on 21 May 2013, the contents of which are hereby expressly incorporated by reference in its entirety, under 35 U.S.C. §119(e).

### TECHNICAL FIELD

This application relates generally to electronic message management. More specifically, this application relates to graphical representation and manipulation of messages from multiple accounts, rendered based on message relevance.

### BRIEF DESCRIPTION OF THE DRAWINGS

The drawings, when considered in connection with the following description, are presented for the purpose of facilitating an understanding of the subject matter sought to be protected.

FIG. 1 shows an example network computing environment wherein the disclosure may be practiced;

FIG. 2 shows an example computing device that may be used in the network computing environment of FIG. 1;

FIG. 3 shows an example horizon view of multiple electronic messages usable with the computing device of FIG. 2;

FIG. 4A shows an example segregated horizon view of electronic messages from multiple accounts usable with the computing device of FIG. 2;

FIG. 4B shows an example mixed horizon view of electronic messages from multiple accounts usable with the computing device of FIG. 2;

FIG. 5 shows example zoom in and zoom out operations on a set of messages in horizon view;

FIG. 6A shows an example graphical interface for filtering and rendering of multiple mixed electronic data and messages;

FIG. 6B shows an example graphical interface for filtering and rendering of a single electronic data or message;

FIG. 6C shows an example user interface for specification of logic expressions applied to combining selected filter, category, or action parameters;

FIG. 7A shows an example graphical interface for filtering and rendering of multiple segregated electronic data and messages, and rendering of a contact ribbon; and

FIG. 7B shows example graphical interface for rendering of multiple electronic data and messages based on relevance information.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references electronic mail (email), it will be appreciated that the disclosure may be used with other types of electronic messages and records, such as SMS, IM, social network posts, text messaging, chat records, files, folders, icons, and the like.

Briefly described, a device and a method are disclosed including a user interface software component configured to dynamically display and manage grouped graphical representations, such as tiles, of electronic data and messages, such as files and emails, that are rendered based on relevance scores, and are associated with two or more user accounts. The messages may be grouped visually or logically. The user interface may automatically categorize messages by assigning certain attributes based on heuristics or other information. The user interface is configured to allow zooming in and out for more or less details, respectively. The user interface is further configured to allow automatic and/or dynamic changes to the appearance and contents of tiles based on the relevance scores and other factors, and further allow searching for, dispositioning, and taking various actions on one or a group of messages.

A number of companies produce office software products, which typically include communication and messaging email and calendaring programs, such as Microsoft Office®, Corel (Word Perfect Suite), Oracle Open Office®, and others. Historically these programs ran and worked locally on the user's computer, using only the resources that were available on the local system. However, in the recent years, many other software applications have been devised and made available that provide various types of communications. With the advent of advanced or smart mobile devices, such as smartphones, SMS, text messaging, and emails are more widely available and used than ever before.

With the ubiquity of reliable and widely available internet access, there is an ever increasing number of electronic messages that are transmitted and/or stored. Accordingly, incoming messages, such as emails and text messages, accumulate fast and are difficult and time consuming to effectively manage. A user interface that can help users quickly view, categorize, search for, disposition, and take appropriate actions on messages is highly desirable.

### Illustrative Operating Environment

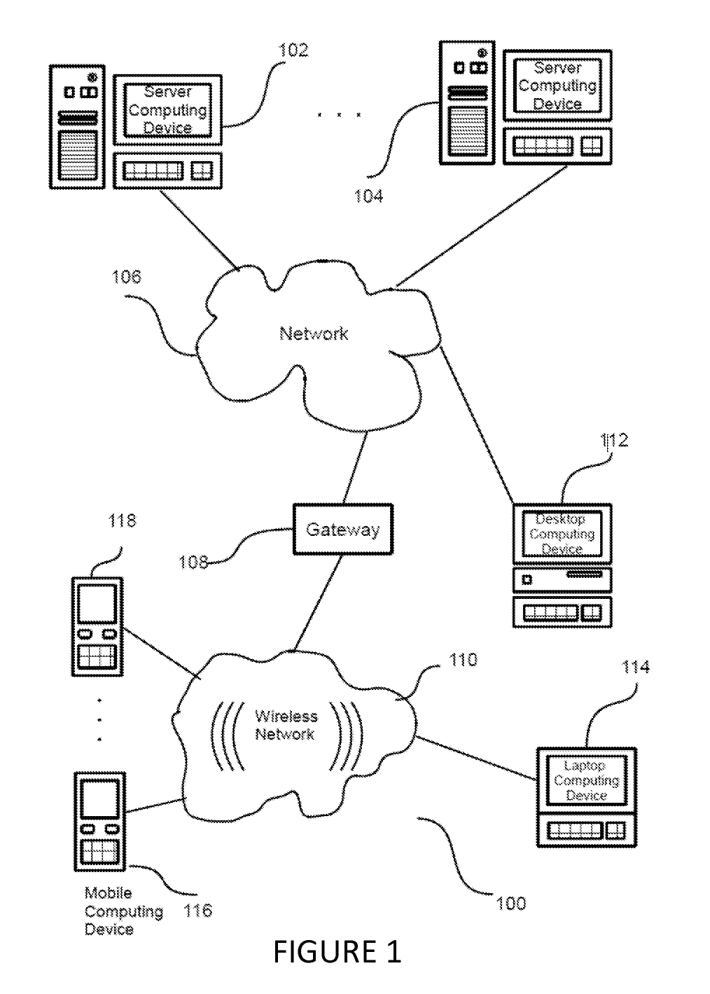

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

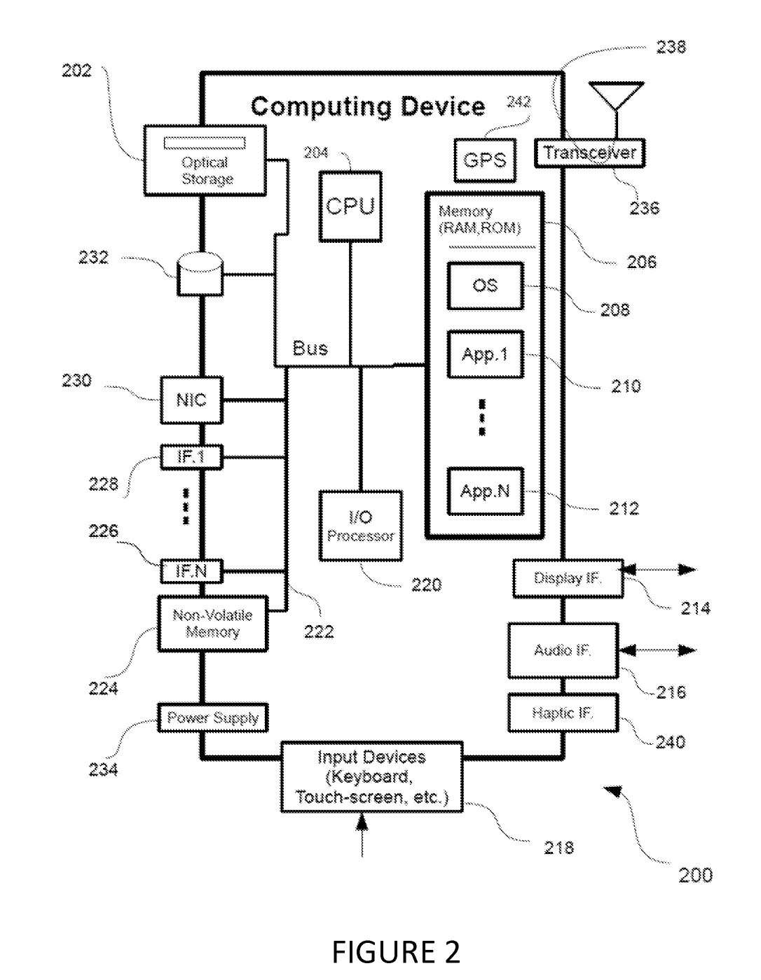

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

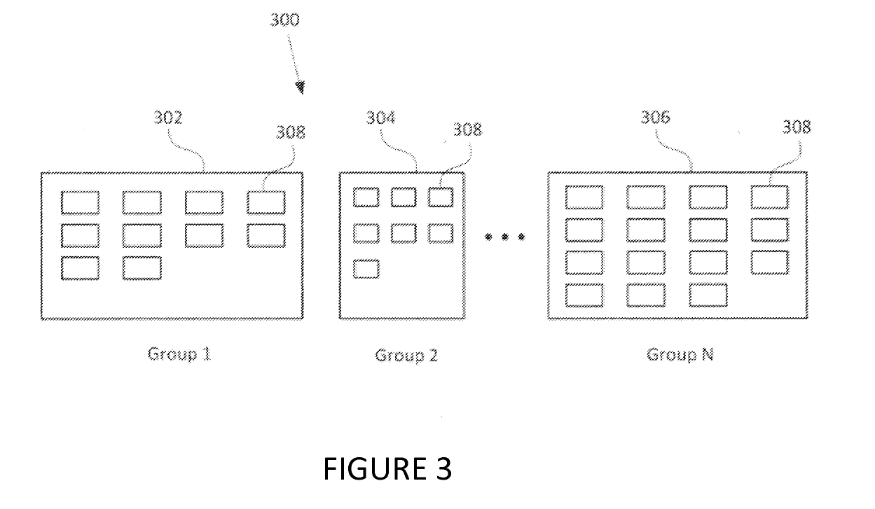

FIG. 3 shows an example horizon view of multiple electronic messages usable with the computing device of FIG. 2. In various embodiments, horizon view 300 depicts many electronic data representations 308, such as email messages, grouped together in various grids representing different groups 302, 304, and 306.

In various embodiments, horizon view 300 may be implemented and displayed by a hardware and/or software system using one or more software components executing on the illustrative computing device of FIG. 2. One or more functions may be performed by each software module. For example one or more separate software components may be used for each of the functions to manage graphics of the horizon view, present a user interface, display tiles or data items, search for tiles, filter tiles and/or data items based on various parameters, apply heuristics, monitor user preferences, generate rules for automatic categorization and/or grouping of electronic data items, and any other function needed to carry out and implement the functions of the horizon view described herein. Those skilled in the art will appreciate that one function may be implemented using multiple software modules or several functions may be implemented using one software module.

In various embodiments, electronic data items may include email, SMS, voicemail, video mail, chat records, files, folders, applications, applets, apps, pictures, images, network nodes, software components, or any other electronic information which may be represented by a graphical component such as an icon or a tile. An icon is usually a static pictogram which when selected, for example, by a mouse click, causes some software actions, such as the launching of an application to take place.

In various embodiments, the electronic data and messages mentioned above and presented in the same horizon view may be associated with one or more user accounts. For example, multiple emails may belong to multiple accounts such as a work account, a personal account, and other hosted organizations. Similarly, personal messages and chat records from various social networks such as Facebook™, Google+™, and the like, may be presented together in the same integrated horizon view distinguished by various visual techniques, such as color coding, display area segregation, and the like. Those skilled in the art will appreciate that all disclosures herein apply to multiple user accounts as well as a single account, as appropriate.

In various embodiments, a tile is usually an active relatively small graphical component and/or user interface, such as an applet or small software application, which displays sample graphical or visual information related to bigger bodies of information related to data items or software applications the tiles represent. When selected, tiles display more complete information, such as file or web page contents, related to the sample information; launch their respective associated applications; or bring them to the forefront of the display and assume focus for the user's input actions. For example, a tile representing an email application may show some information about the email inbox such as number of new messages, fragments of the most recent message, and the like. As another example, a tile representing a message, may display an image of the sender and overlay some text from the message, such as its subject line. Tiles are generally dynamically updated to reflect the change of data in the applications they represent. Tiles may be considered as small live windows to the applications they represent, thus, efficiently showing the user status and other information about multiple applications, which otherwise would not be possible due to the limited size of the computer screen. So, for a given screen size tiles can display information about a greater number of applications or data items than could be done with full applications. Those skilled in the art will appreciate that any image, on a paper, a computer screen, or otherwise, is a projection on a plane having two dimensions, usually referred to as X and Y dimensions or axis, also referred to as X-Y plane. However, In various embodiments, an arbitrary number of dimensions may be included in the image using various visual effects or data manipulations. In this context, a dimension is any variable, parameter, or category of information related to a graphic representation of data. For example, in a message, various dimensions may include time, sender, receiver, priority, relevance, importance, thread, subject category, and the like. In a static image only two such parameters may be displayed. But in a dynamic image an arbitrary number of such parameters may be accessed via various techniques described below.

To access such additional information or dimensions various techniques may be used. For example, 3-D visual effects, such as perspective projection with stacked data items, may be used to show an additional Z-axis. Stacked data items show a stack of items at one point or coordinate in the X-Y plane, so that for every point on the X-Y plane a group of items exist, instead of a single data item. This technique effectively provides the Z-axis on the X-Y plane. More dimensions may be included in a dynamic image on an electronic display by various navigation and manipulation techniques to access more information related to a particular area of the image, such as drill-down into the area, opening stacked data items, context driven menu items by selection of the area, or any other graphic technique that allows retrieval of additional information, each corresponding to a different dimension.

In various embodiments, in addition to explicitly defined dimensions, attributes, or parameters, described above, information, such as meta data related to electronic data items like messages, may be contained in other aspects of the graphical representations, such as in color, shape, texture, imagery, and size, among others. For example, in the context of messages, icons or tiles representing older messages may be shown with faded colors, while newer messages may be represented with the same but a more vivid color. Similarly, older messages may be shown as smaller icons while newer ones are shown as larger icons. As another example, if a sender is known to the user, the messages from the sender are displayed with bright colors, while more faded colors may be used for lesser known or unknown users. Those skilled in the art will appreciate that various graphical attributes such as color, texture, size, and shape, among others, may be used to encode or indicate various information such as meta data, as described above.

Those skilled in the art will appreciate that variations in any the these graphical attributes may be used to differentiate between different data items or their associated meta data. For example, texture, size, color, screen position/location, or other visual attributes of graphical representations such as icons may be varied to indicate the relevance of a particular electronic data item (e.g. a message) to a current activity the user is engaged in. Again, in a messaging context, if the user is reviewing his emails, more prominent attributes may be used to represent emails that are more relevant to a thread, sender, time period, subject, and the like. For instance, a more relevant email may be displayed with bolder texture, more vivid color, or in larger size relative to other emails.

Generally, relevance indicates how closely an item or a result is related to a desired objective or activity. In various embodiment, the relevance may be based on one or more various relationships or parameters that are predefined, dynamically and automatically determined based on usage history or user preferences, or explicitly specified by the user. For example, in a messaging system such as email, a particular email may be considered as being more relevant if its time parameter is recent and it has the same subject line as other emails that the user has recently opened. Any combination of parameters or relationships may be used to indicate relevance, depending on the application or user preferences.

In various embodiments, the characteristics of visual or graphic representation of electronic data items may be automatically determined based on context, history of usage, or set preferences. In other embodiments, such characteristics may be set by a user via a user interface for setting preferences. More specifically, visual characteristics of data items may be automatically assigned based on item category, relevance, priority, history of usage or preferences, location (obtained from GPS, cell towers, user input, etc.), importance, and the like. For example, a highly relevant data item related to a particular project may be displayed as a larger icon with bright colors in the center of the display screen, while less relevant data items may be displayed as small gray items on the side of the display screen.

In various embodiments, automatic machine or self-learning of relevance factors and the preferences of the user may take place by the system implementing the data item management user interface, based on the user behavior, preferences, user's responsiveness to a type of message, amount of time user spent on a type of message, and usage history of the various electronic data items. For example, in a messaging context, the system may learn that messages from a particular sender or on a particular subject as characterized by certain keywords, cause the user to respond immediately or spend more time on the message. In such case, the system may display the messages that fit the learned criteria more prominently, for example, by size, screen placement, color, or other attributes. Those skilled in the art will appreciate that many other parameters and techniques may be used to learn without departing from the spirit of the present disclosures. For example, duration of time the user spent on a particular data item fitting certain conditions, whether the user filed the email or data item in a folder, searches performed on such data items, and the like, may be used to develop a pattern of usage to identify future data items matching the same criteria or patterns.

In various embodiments, parameters, attributes, or criteria assigned to a dimension, such as X, Y, or Z dimensions, allow ordering of data items displayed along the dimension. For example, if X-axis is assigned the time parameter, then email messages received may be ordered and displayed on the screen according to the time of delivery, time of sending or opening, or other time criteria. Similarly, a dimension may be assigned an alphanumerically ordered parameter, such as sender name or ID. One or more dimensions may be ordered, each based on a different order. For example, the X-axis may be ordered by time, while the Y-axis is ordered by priority.

As another example, the X-axis and Y-axis project a coordinate system guiding the placement of messages. The X-axis may project orderable categories defined by time ranges, such as Today, Yesterday, Last Week, Last Month, etc. The Y-axis may project some other categorized domain, which may include at least the following and other categories: work related, personal, shopping and promotions, TEXT-messages, social-network messages, v-mails (voice mail), and miscellaneous. As can be appreciated by those skilled in the art, multiple messages may fall onto the same coordinates, for example, Today and Work categories. These messages may be stacked or organized in small sub-grids 302-304-306, resulting in a grid-of-grids 300, where the coordinates of each sub-grid imply the message time and context. Effectively, this arrangement is similar to an attraction map of a city, except that it is a map of messages.

Those skilled in the art will appreciate that ordering is not limited to predefined ordered sets such as the set of integers, date and time, or alphabetical sets. Other sets of values for a particular parameter may be provided, which are ordered according to a predefined enumeration. For example, a set of subjects or names may be specified in a set and each assigned an order with respect to the other set members. In some embodiments, the order may be calculated dynamically. For example, a relevance score may be calculated, based on various criteria described above, for each electronic data item and used to order the display of the data items.

In various embodiments, the grids' and tiles' visual characteristics are automatically adjusted. The order, size, arrangement, color, and other visual characteristics of the electronic data items, such as messages, may be determined and/or adjusted by the system automatically without user involvement. For example, in a messaging context, the tiles representing individual messages or groups of messages may be arranged based on chronological order, each with varying sizes and colors based on age, relevance, subject, sender, message category, past user behavior, message priority, user preferences, or other criteria. Similarly, the shape and size of the grids of grids, in the horizon view, may be automatically determined and dynamically updated as conditions change. For example, as new messages come in, they are displayed with more vivid and bright colors, by varying color hue, saturation, intensity (or value or lightness), and in larger size, while older messages are reduced in size and shown in faded colors to deemphasize the old or less relevant messages.

In various embodiments, electronic messages and records, such as SMS, text messaging, social network posts and/or messages, chat records, files, folders, icons, and the like may be automatically clustered to form groups of similar data records. In the case of emails, such groups may include subject-based categories like “Inbox,” “Sent,” “Personal,” “Work,” and the like. Similarly, such groups may include period or time-based categories like “Today,” “Yesterday,” “Last Week,” and the like. Those skilled in the art will appreciate that for different types of electronic data, different types of groups or categories may be defined as appropriate for the type of data. For example, for file and folder data, the categories might be subject-based, size-based, project-base, person-based, time-based, file type-based, or any other appropriate and useful category that may be used to group files and folders.

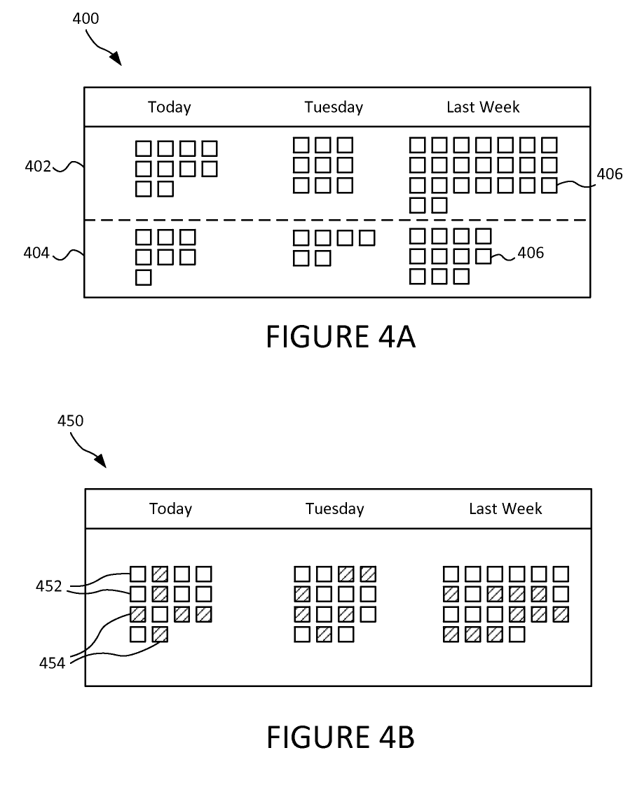

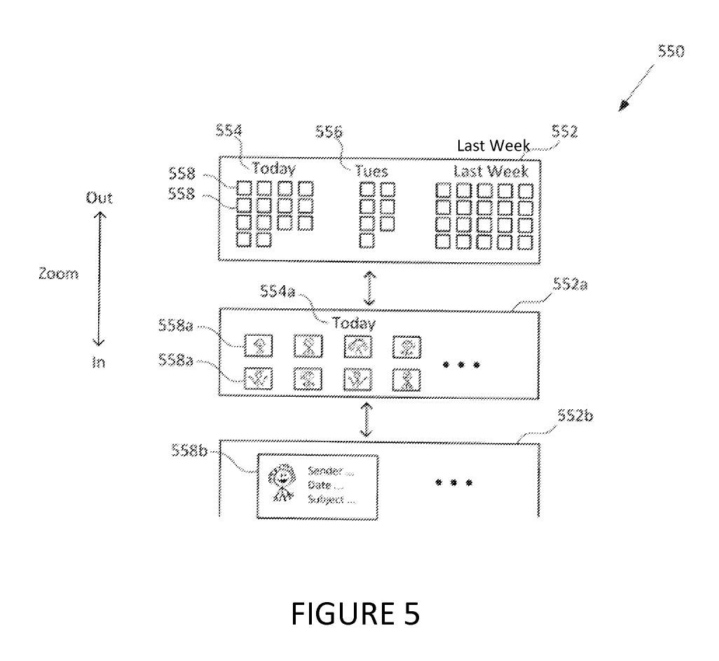

Horizon view allows quick review of electronic data, such as emails, at a high level, without having to closely examine individual emails or folders. For example, the horizon view might include the number of data records and other statistical information associated with each group. This way, a user may quickly obtain useful statistics about the group. In various embodiments, further details about single records, such as email messages, may be obtained by using various zoom operations as further described below with respect to FIGS. 4A, 5, and other figures.

In various embodiments, the horizon view, when deployed on a computing device with a multi-touch screen, provides easy and fast touch techniques for manipulating one or a large group of data records, such as emails. For example, groups may be shuffled around and manipulated by a swiping action of a finger. Similarly, a group may be zoomed in or zoomed out by a pinch-in or pinch-out action of two fingers, revealing more or less information about the zoomed group.

In some embodiments, a group of data records or a single data record may be selected to be dispositioned or to have other appropriate action taken on it. For example, an email may be selected to be transferred to the “Personal” folder or be marked as “Read.”

In some embodiments, a range of an appropriate quantity, such as time period, in a group may be selected for further actions. For example, in time-based groups, a range of three days may be selected to further examine in details, as further described below with respect to FIG. 4A.

In some embodiments, electronic data items grouped together as grids or grids of grids, may be color coded to easily visually identify different groups. The grids may be nested to an arbitrary depth, each nested set representing a level. For example, the top level grid may be level 1, the next nested level may be numbered level 2, and so on. Each grid level may have its own characteristics and attributes, some or all of which are shared with the higher or lower level grids. In a messaging context, if time is used for nesting grids, the top level may represent a year and/or month, the next level may represent a week or day, and the next level may represent a sender or a thread of conversation. Each of these levels may be represented by a different color, shape, meta data, and the like. The zoom operations described herein may be used to move between grid levels by zooming in and out.

In other embodiments the data items may be identified and displayed by geometric shapes like squares, circles, triangles, and the like, or by irregular shapes such as silhouettes of objects, people, or animals, or any other shapes easily distinguishable from others. In still other embodiments, a combination of shapes, colors, and textures may be used to group items together to distinguish them from other groups. At each zoom level (or level of detail) various distinguishing characteristics, such as color, shape, texture, marks, flags, indicators, text, and the like may be used to distinguish groups or items from others, at that level.

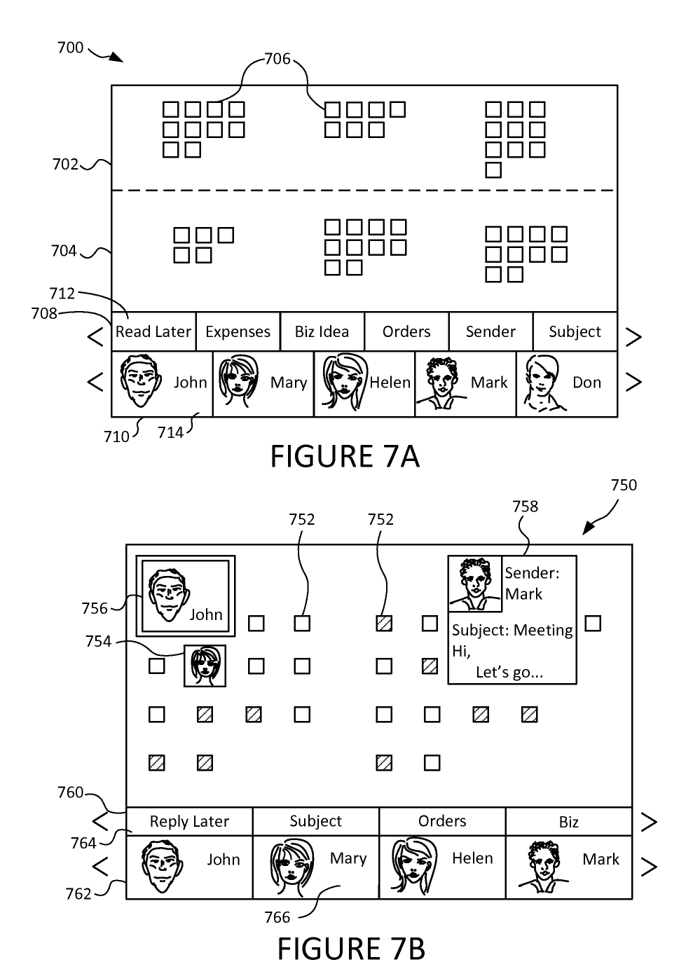

In various embodiments, the categorization of messages or other electronic data items may be done automatically, based on heuristics, machine learning, neural networks, history of user behaviors, user preferences, and other factors, described later with respect to FIG. 7B. Similarly, appropriate action categories may be assigned to messages automatically based on similar factors. The automatic categorization software module may learn the user preferences by observing her actions and apply the learnt patterns to the incoming and existing email or other data items. The categorization may be performed by one or more of predefined rules (Example, recognizing offers by a particular commercial concern such as Groupon emails), neural networks, heuristics, and machine learning techniques. The user interface software module may allow the user to manually configure auto grouping/categorization rules, or adjust the automatically learnt rules.

FIG. 4A shows an example segregated horizon view of electronic messages from multiple accounts usable with the computing device of FIG. 2. In various embodiments, horizon view 400 includes separate or segregated views 402 and 404, each associated with different user accounts and each including electronic data items 406, such as emails, groups.

In various embodiments, electronic data items and messages, such as emails, from several different accounts may be presented in the same horizon view but separated based on the account association. Each of the attributes of the messages in the horizon view, such as subject, sender, date range, and the like described above, apply to each of the segregated views. In some embodiments, a common grouping is applied to the electronic data items, for example, emails, associated with each account, while in other embodiments, each account's emails are grouped separately. For example, emails for account 402 and account 404 may be grouped according to the same date ranges such as “Today,” “Tuesday,” and “Last Week,” or each account's emails may be grouped according to a different date range. In effect, when grouped separately, each account is like a separate horizon view appended with other horizon views, while some of the controls, filters, and other facilities of the horizon view may be shared between the horizon views.

FIG. 4B shows an example mixed horizon view of electronic messages from multiple accounts usable with the computing device of FIG. 2. In various embodiments, horizon view 450 includes electronic data items and messages 452 and 454 associated with different user accounts, respectively, but displayed in a mixed format together and visually identified by an indicator.

In various embodiments, the electronic data items 452 and 454, which belong to different user accounts, are identified using various visual indicators, such as color, shape, size, borders, textured surface, tags, flags, marks, and the like. This arrangement allows easy grouping of emails or other electronic data such as files, regardless of the account they belong to.

In various embodiments, the display of tiles representing such electronic data items, may be switchable from the mixed mode shown in FIG. 4B to segregated mode shown in FIG. 4A and vice versa, under user control.

FIG. 5 shows example zoom in and zoom out operations on a set of messages in horizon view. In various embodiments, horizon view 550 includes groups of data items 554 and 556 on a screen 552, each group including data items 558. Zooming in transforms group 554 to more detailed group 554a and more detailed data items 558a on screen 552a. Zooming in further reveals more details about data items 558b in screen 552b. For example, group 554 in a high level (low detail) state horizon view shown on screen 552 may include email messages from today. Zooming in to a mid level (mid detail) state shown on screen 552a reveals more details about the group and the data items 558a contained therein, such as small icon-type pictures of senders, colors, or other similar information. Zooming further to a still lower level (more detailed) state shown on screen 552b provides more details about individual data items such as clearer pictures, more colors, text, marks, and the like.

Those skilled in the art will appreciate that generally a zoom-in operation is a traversal from a high-level view (low detail) of a data item to a low-level view (high detail), and a zoom-out operation is a traversal in the reverse direction. Each type of specific zoom may provide a different type of detail. For example, the contextual zoom operation provides context-based detail, the semantic zoom provides relevant details to the level of zoom or detail, and the metadata zoom provides metadata which is directly or indirectly relevant to the zoomed data item at the given zoom level.

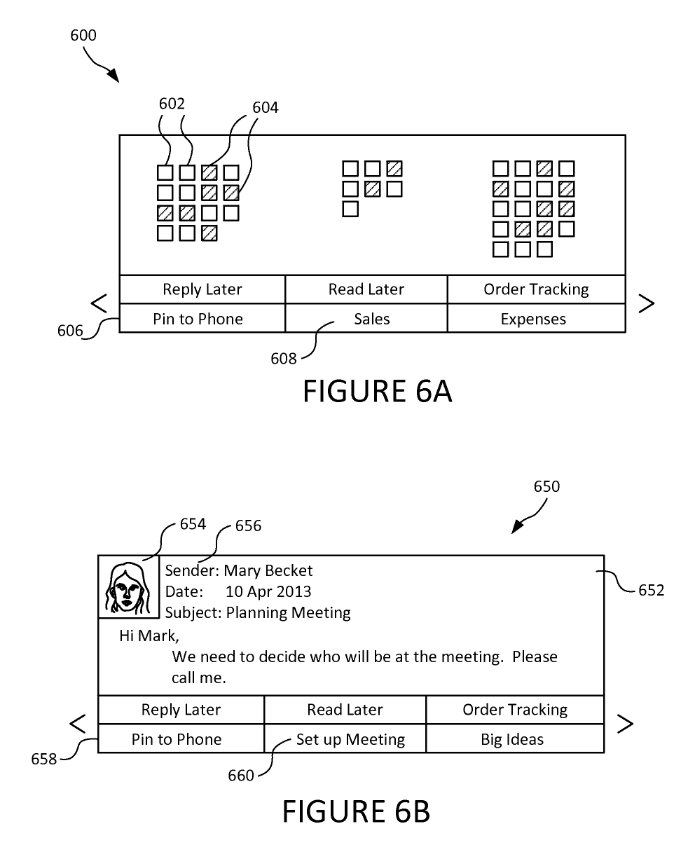

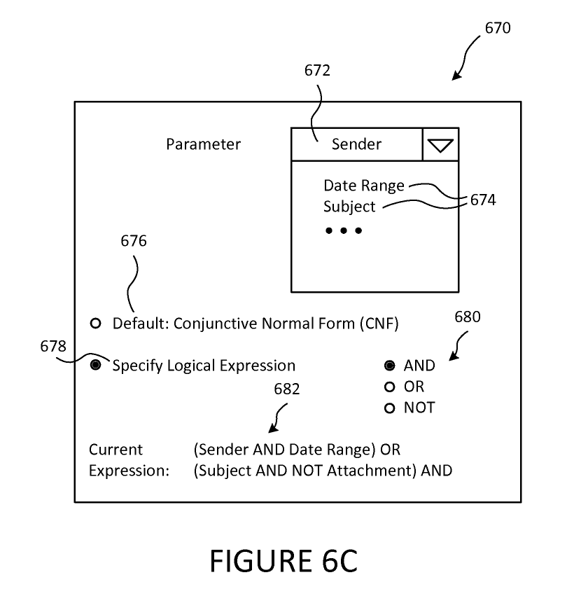

FIG. 6A shows an example graphical interface for filtering and rendering of multiple mixed electronic data and messages. In various embodiments, horizon view 600 includes mixed messages 602 and 604 from different accounts, respectively, control strip 606 including category or filter parameters 608.

In various embodiments, horizon view may include segregated accounts such as shown in FIG. 4A. The control strip or ribbon 606 may include any parameter or attribute of the electronic data items which may be used to take an action on, or select or group such data items. These control parameters, which may also be regarded as categories of messages or electronic data items, may be used to take some action on the messages or to filter the messages according to some criteria. The action parameters may include actions such as “Read Now,” “Read Later,” “Delete,” “File,” “Reply Now,” “Reply Later,” “Forward,” “Flag,” “Mark Urgent,” “Mark as Spam,” “Move,” “Pin to Phone,” “Pin to Tablet,” “Set up a Meeting,” “Follow up,” “Review,” and the like.

The control parameters may also include criteria or attributes for filtering and/or grouping the electronic data items or the tiles that represent them. The message attributes such as “Sender,” “Priority,” “Read/Unread,” “Date Range,” “Receiver,” “Subject,” “Has Attachments,” and the like may be used to select, group, or sort according to the value of such parameters. For example, to see messages from a particular sender or for particular date range, the user may select the corresponding parameter from the control strip 606. Additional user interface controls, such as buttons, may be used to indicate whether the user wants to filter, sort, or group the messages according to his selection. For example, the user may select the “Sender” parameter from the control strip and enter “John” as the sender in a dialog box or a presented text field to show only messages from John. The user may also select the “Sender” parameter to filter, grop, and/or sort all messages in terms of their senders. When grouping messages by “Sender,” their respective tiles (or other graphic representations) are grouped together in sub-grids associated with the respective senders. The filter parameters may also include categories of messages, which indicate their general purpose such as “Sales,” “Business Ideas,” “Expenses,” “Order Tracking,” “Project XYZ,” and the like. These filter parameters may be used to further classify or filter messages.

In some embodiments, the user may define his own control parameters as relevant to his environment. For example, a user in the shipping business may define and associate control parameters such as actions, categories, or filter parameters with his emails, which may be different from those defined by a user in a medical facility. As an illustration, a user in the shipping business, may include “Tracking Number” as a sorting or filtering parameter, while a user in the medical facility may include a “Doctor,” or “Office” parameter.

In various embodiments, multiple control parameters may be selected by the user as logically ANDed or logically ORed together. Those skilled in the art will recognize that to logically AND two or more conditions together requires both or all conditions to be satisfied before an action is taken or a result is produced, while to logically OR two more conditions requires at least any one or more conditions to be satisfied before the action is taken. The logical functions may be selected by the user, in some embodiments. For example, if the parameters are ANDed together, then selecting “Sender” and “Date” causes all messages that are from the particular sender and received in the given date range to be displayed, or grouped together in the horizon view. And if the parameters are ORed together, then any message that matches at least one of the selected sender or date range will be displayed.

In various embodiments, the selection of various control parameters or categories 608 may include a toggle function that turns the selected parameter ON or OFF each time it is selected. Those skilled in the art will appreciate that many other software selection controls may be used without departing from the spirit of the present disclosures. For example, radio buttons, checkboxes, pick lists, and the like may be used to select a particular control parameter. Multiple parameters may be selected at the same time. For example, hi-priority messages, received last week, from John Doe, with attachments.

Once one or more control parameters are selected, they are ANDed or ORed together, depending on the embodiment or setup of the system, or preferences set by the user, and then the electronic data items, such as emails, are displayed, sorted, filtered, grouped or categorized accordingly. The resulting action, such as messages being displayed, sorted, filtered, grouped or categorized, may be determined by additional settings, preferences, or controls indicating the desired result. For example, the user may indicate that he wishes the matching emails to be filtered according to the selected parameters. In such case, only the matching messages are displayed in the horizon view while all other messages are hidden. Alternatively, the user may set the results controls (that is, the software controls that control the results) to group the emails together according to the selected criteria. In such case, each selected control parameter may be used as a basis for grouping the emails. In some embodiments, one email may fall into several groups and be displayed redundantly, while in other embodiments, one email is assigned to a group based on a weighting or relevance function that determines the most relevant basis for assigning a particular email to a particular group. Similarly, a sorting function may be defined based on a weighted combination of selected parameters which provides an ordered list of emails, so sorted. A similar process may be applied to a single email but with more limitations, as further described below with respect to FIG. 6C.

In various embodiments, the grouping of the tiles may be visual or logical. Visual grouping provides on-screen grouping of tiles allowing the user to see the grouped tiles in close vicinity of each other. Logical grouping is created when different tiles, or the electronic data items they represent, share common characteristics or belong to the one or more common categories. For example, if emails over the same time period, such as “Last Week,” are grouped together visually on the screen, the tiles representing such emails will appear in close proximity to each other on the screen. If a number of emails belong to “Project XYZ” and “Reply Immediately” categories, then such emails may be grouped with each other only logically and may not appear together on the screen. Generally, a set of emails may be both grouped visually and logically based on different criteria.

With continued reference to FIG. 6A, the arrows on the left and right sides of the control strip 606 indicate that more control parameters may be brought into user's view by swiping the control strip left and right or otherwise scrolling the control strip from side to side, or up and down.

FIG. 6B shows an example graphical interface for filtering and rendering of a single electronic data or message. In various embodiments, graphical interface 650 includes a single electronic data item such as email 652 including a contact picture 654, textual and graphical contents 656, and control strip 658 having category or control parameters 660. The contact picture may be associated with the sender, the receiver, or others included in the message for example in CC and BCC fields. Other data items such as audio and video data may also be included in the message.

Since a single electronic data item cannot be grouped or filtered, some of the functions and processes described above for multiple messages do not apply to a single item. However, other actions and categories do apply in a similar fashion. In some embodiments, the category parameters may include actions such as “Read Now,” “Read Later,” “Delete,” “File,” “Reply Now,” “Reply Later,” “Forward,” “Flag,” “Mark Urgent,” “Mark as Spam,” “Move,” “Pin to Phone,” “Pin to Tablet,” “Set up a Meeting,” “Follow up,” “Review,” and the like.

In some embodiments, messages associated with the same categories or assigned the same actions, such as all messages assigned the action category “Pin to Phone,” or all messages sent last week, may be searched for or grouped by their category associations and treated the same way. For example, those messages that were assigned the action “Pin to phone” will be consequently pined to the phone to allow easy access when traveling.

Similarly, the category parameters may include categories of the message, which indicate its general purpose such as “Sales,” “Business Ideas,” “Expenses,” “Order Tracking,” “Project XYZ,” and the like. These category parameters may be used to further classify the message.

In some embodiments, the user may define his own control parameters as relevant to his environment. For example, a user in the shipping business may define and associate control parameters such as action or category parameters with his emails, which may be different from those defined by a user in a medical facility. As an illustration, a user in the shipping business, may include “Tracking Number” as a sorting or filtering parameter, while a user in the medical facility may include a “Doctor,” or “Office” parameter.

With continued reference to FIG. 6B, the arrows on the left and right sides of the control strip 658 indicate that more control parameters may be brought into user's view by swiping the control strip left and right or otherwise scrolling the control strip from side to side, or up and down.

FIG. 6C shows an example user interface for specification of logic expressions applied to combining selected filter, category, or action parameters. In various embodiments, graphical user interface 670 includes parameter choices 674 in a drop-down list 672, default logical expression 676, option for specifying arbitrary logical expression 678, logic operations 680, and current logical expression 682. In various embodiments, the filter, category, or action parameters selected by the user may be combined according to a logical expression. The most common logical combination is the Conjunctive Normal Form (CNF), which logically ANDs together a number of OR'd sub-expressions or logical clauses, such as: (A OR B OR C) AND (D OR E OR F), where A, B, C, D, E, and F are parameters to which the logical expression is applied.

In various embodiments, using CNF, different parameters are AND-ed, while their values are OR-ed. The contact strip (see FIG. 7A) is an example of this application of CNF. CNF may also be applied to the selection of multiple categories to be displayed, and date/time range selector, which allows the user to choose any of “today”, “yesterday”, “this week”, “last week”, “this month”, “last month”, “Feb”, “Jan”, “last year”, “older”- and the like.

More generally, in some embodiments, any Boolean expression may be applied to the selected parameters. In this embodiment, the user may select one parameter at a time, for example, from the drop-down list of parameters 672, and specify one of several logic operations 680, such as AND, OR, and NOT, to build a logical expression 682. Subsequently, as the user is filtering, categorizing, or taking other actions on various data items or messages, the predefined logical expression 682 is applied to those parameter selections to determine which messages are displayed, categorized, or acted upon.

FIG. 7A shows an example graphical interface for filtering and rendering of multiple segregated electronic data and messages, and rendering of a contact ribbon. In various embodiments, multiple segregated accounts horizon view 700 may include a first account horizon view 702, a second account horizon view 704, electronic data items, such as emails 706, control strip 708, contact strip 710, control parameters 712, and contacts 714.

In various embodiments, horizon view is substantially similar to that shown in FIG. 6A, with the addition of contact strip 710. The contact strip shows a selection of the most relevant contacts 714 based on the selection of the control parameters 712 and the resulting emails displayed. For example, if control parameters 712 are selected to filter according to “Sender” and “Date,” then the contact shown may be the senders and/or the recipients of the matching emails. In various embodiments, the user may scroll the contact strip to see other contacts not automatically selected for display. The scrolling may be done as described for the scrolling of the control strip 606 with respect to FIG. 6A.

In various embodiments, the contact strip 710 may include contact information for individuals, lists of individuals, distribution lists, companies, organizations, departments, projects, institutions, job functions or roles, or any other entity which may be assigned contact information. Compound contact strip items which may include other contact list items and other compound items, such as contact lists or distribution lists which include other lists or individual's contact information, may be parsed as needed to extract the items within them for filtering, categorization, or action. For example, if a particular sender is selected for whom the emails are to be displayed and that individual is only part of distribution list, then only the name of the particular sender is extracted from the distribution list and displayed in the contact strip.

In various embodiments, when the user selects an image from the contact strip 710, all messages from the selected contact are displayed. The user may select multiple contacts and/or their respective images, in which case the messages sent from all the selected contacts are displayed. In some embodiments, the contact strip may include representations or images of “me” and “others,” where “me” is the user. When the user selects the “me” image, the messages sent by the user to herself are displayed in the horizon view. When the user selects the “others” image, all messages sent by any other contact whose image is not currently displayed in the contact strip are displayed in the horizon view. This is useful because not all contact names a user has in her contact list are displayed in the contact strip due to limited screen space and/or filtering chosen by the user. Those skilled in the art will appreciate that contacts in the user's contact list and/or contact strip are not limited to being senders and may appear in the “Sender” field, the “To” field (receiver), the “CC” field (Carbon Copy), the “BCC” field (Blind CC), and any other field that may contain a contact name in a message.

In various embodiments, heuristics may be used to determine what contacts to display in the contract strip, as well as how to render electronic data items, such as messages and emails in horizon view. Heuristics are imprecise rules, such as rules of thumb, common sense, model-based estimates, educated guesses, idealized rules, rules based on assumed conditions, and the like, used to find solutions to problems which are too difficult or impossible to solve analytically or precisely, or that take too long to solve under the circumstances. Heuristic rules may be obtained based on user behavior coupled with assumptions about user preferences or needs.

Data mining may be also used to generate heuristics. Data mining is a computerized technique of searching for and finding patterns in large amounts of data. Such patterns are formulated as rules to apply in taking various actions. For example, user preference or behavior data may be accumulated in a database and mined for user patterns of behavior when emails come from particular senders, on particular subjects, or on particular days. Based on such patterns, rules may be automatically generated to apply to the display of selected contacts in the contact strip, for example, to determine which contacts are to be displayed and in what order.

In various embodiments, heuristics, machine learning, or other pattern-based techniques for rule generation may be embodied in hardware or software neural networks. Neural networks are hardware or software circuits or components that adapt their output according to the input they received the feedback they get from their outputs. Several types of neural networks exist, however, they are generally based on neural elements, similar to natural neurons or nerve cells, which are connected together with connections called synapse. The synaptic connections are strengthened or weakened based on the feedback they receive and how they compare to a reference value. This way, neural networks can be trained to recognize a particular input pattern. The input patterns may be any combination of parameters that are to be identified, such as sender of a message, subject of the message, or date of the message. Rules generated using neural networks may be applied to the rendering of tiles or listing of contacts as any other rules.

Heuristics may further be developed based on telemetry data as further described below with respect to FIG. 7B.

In some embodiments pre-programmed or pre-defined rules may be used. For example, a rule may state: “If a meeting is approaching, then the contacts of the meeting participants are to be included in the contact strip.” This rule may be refined to consider the user current location and whether he commutes to the meeting.

In various embodiments, a pivoting operation may be applied to horizon view, similar to the pivoting operations of popular spreadsheets, such as Microsoft's Excel™ spreadsheet, to allow the viewing of summary data. Those skilled in the art will appreciate that the pivoting operation aggregates various categories and shows summary information. For example, the result of a pivoting operation may include the total number of emails sent during a particular period or from a particular sender.

In some embodiments pivoting may rearrange the selected messages according to filter parameters such as their received time, sender, category and the like. The pivoting works in conjunction with the various filtering and searching mechanisms. This way, only those messages that meet the criteria set via the selected parameters are displayed in the current pivot. FIG. 7B shows example graphical interface for rendering of multiple electronic data and messages based on relevance information. In various embodiments, horizon view 750 includes electronic data items, such as messages 752, 754, 756, and 758 with various levels of detail, control strip 760 having control parameters 764, and contact strip 762 having contacts 766.

In various embodiments, messages 752-758 are rendered based on relevance information. As parameters 764 applied to filter or group messages in the horizon view, as described with respect to FIGS. 6A-7A, the messages that match the criteria are rendered on the display. In some embodiments, however, not all messages or software data items match the selected control parameters equally. In various embodiments, the control parameters 764 may be weighted to indicate their respective importance. The messages which match the more important criteria may also be deemed more important than other messages, and thus, be rendered more prominently and/or in more detail. The strength of match is one measure of relevance of the messages to the user's needs and intentions.

Other relevance criteria may be used to render the messages and/or list contacts in the contact strip. Such relevance criteria may be based on telemetry information. Telemetry information are measurement data usually obtained automatically and remotely and sent for storage or use to a point of use location. Telemetry data may be as simple as the count of a parameter or as complex as calculated results obtained from a combination of multiple parameters. For example, telemetry data for messages like emails, may include the number of emails sent on each day, the number of emails sent from a particular sender over some time period like a week, or the size of the email and number and type of attachments. Those skilled in the art will appreciate that many other telemetry data may be generated and used without departing from the spirit of the present disclosures. For example, telemetry data may further include how many times the user replies immediately to a particular sender of messages, how long the user spends reading a particular message, how long the reply to a message is, what account is the message associated with, and the like.

In various embodiments, telemetry and other data may be used to calculate a relevance score for the electronic data items, such as emails, and/or for contacts. A relevance score may be a number, a letter, or any other relative, absolute, or ordered quantity, which may be used to assign relevance to an item. The higher the relevance score of a message, the more prominent and detailed the display of tiles associated with the message. For example, if a relevance score of 5 is considered higher than a relevance score of 3, then the data items with relevance score of 5 are displayed with more details, larger, with different colors, different positions on the display, and the like, than the data items having a relevance score of 3. Those skilled in the art will appreciate that relevance score may be ordered from high to low, or low to high, and such assignments have no intrinsic meaning other than what the user or the system assigns to them.

In various embodiments, contacts listed in the contact strip may also be displayed larger or more prominently if they have a higher relevance score. For example, a contact with a higher relevance score may be displayed as large clear picture with full name, while a contact with lower relevance score may only be displayed as a thumbnail image without a printed name. Another example of how relevance affects the display of data items is that the contact order in the contact strip, and whether they are included, may be determined by their relative relevance.

In various embodiments, the tiles in the horizon view and/or the contacts in the contact list may be dynamically and/or automatically updated to reflect changing parameter values. For example, if the relevance score of a tile is at 6 on some scale based on how recent the corresponding email was and having an attribute of being part of “Project XYZ,” then as time passes, the relevance score may be reduced and thus the tile may be displayed in smaller size and with fewer details.

In various embodiments, once the telemetry data are gathered, rules may be generated based on a power-set of the data. The power-set of an original set is the set of all subsets of the original set. For example, the power-set of a set of data including a sender of a message, existence of attachments to the message, and size of the message is all the combinations of these three set members.

In various embodiments, the electronic data items may be automatically assigned categories or attributes without explicit or direct user input. Automatic categorization, grouping, or filtering may be performed based on heuristics, user behavior patterns, history of explicit categorizations by the user on particular types of emails with particular attributes, and the like. For example, if the user usually, assigns “Reply Immediately” to emails associated with “Project XYZ” or a particular sender, then the messaging system or the horizon user interface software may automatically assign “Reply Immediately” to new emails associated with “Project XYZ” or the particular sender. In various embodiments, this self-categorization of messages may be done based on preset user preferences, or by system default.

In various embodiments, data sources external or internal to the messaging system may be used to collect and use data for generating rules of rendering tiles in the horizon view. For example, data in the user's calendar, such as names of contacts, project names, appointments, and the like may be correlated with emails to generate relevance scores. It will be understood that each process step in various methods described herein can be implemented by computer program instructions. These program instructions may be provided to a processor to produce a machine, such that the instructions, which execute on the processor, create means for implementing the steps described. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps to be performed in parallel. Moreover, some of the steps may also be performed across more than one processor, such as might arise in a multi-processor computer system. In addition, one or more steps or combinations of steps discussed throughout this disclosure may be performed concurrently with other steps or combinations of steps, or even in a different sequence than illustrated without departing from the scope or spirit of the disclosure.

It will also be understood that each step and combinations of steps can be implemented by special purpose hardware based systems which perform the specified actions or steps, or combinations of special purpose hardware and computer instructions.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A method of rendering electronic data items, the method comprising:
organizing groups of electronic data items into a horizon view configured to allow viewing and manipulating large numbers of electronic data items associated with multiple user accounts;
associating an indicator with each of the electronic data items to identify an account of the multiple user accounts with which each electronic data item is associated;
calculating a relevance score for the electronic data items; and
displaying the data items having higher relevance scores with more details than the data items having lower relevance scores.
